(19) United States
(12) Patent Application Publication
(10) Pub. No.: US 2020/0182818 A1
(43) Pub. Date: Jun. 11, 2020

(54) TESTING SYSTEM BASED ON SENSITIVITY OF HUMIDITY SENSOR

(71) Applicants: SHENZHEN GUOHUA OPTOELECTRONICS CO., LTD., Shenzhen, Guangdong (CN); ACADEMY OF SHENZHEN GUOHUA OPTOELECTRONICS, Shenzhen, Guangdong (CN); SOUTH CHINA NORMAL UNIVERSITY, Guangzhou, Guangdong (CN)

(72) Inventors: Guofu ZHOU, Shenzhen, Guangdong (CN); Rui ZHOU, Guangzhou, Guangdong (CN); Zhenpeng SHEN, Guangzhou, Guangdong (CN); Nicolaas De ROOIJ, Shenzhen, Guangdong (CN)

(21) Appl. No.: 16/478,753

(22) PCT Filed: Dec. 12, 2017
(86) PCT No.: PCT/CN2017/115690

§ 371 Date: Jul. 17, 2019

(30) Foreign Application Priority Data
Oct. 17, 2017 (CN) 201721372794.X

(51) Int. Cl. G01N 27/22

(52) U.S. Cl. CPC G01N 27/223; G01N 27/228

(57) ABSTRACT

A testing system based on sensitivity of a humidity sensor includes a humidity sensor to be tested, a capacitance measuring circuit and an upper computer, wherein an input end of the humidity sensor to be tested is connected with an output end of a gas quality and flow controller, and an input end of the gas quality and flow controller is connected with an output end of the upper computer through a data acquisition card; and an input end of the capacitance measuring circuit is connected with an output end of the humidity sensor to be tested, and an output end of the capacitance measuring circuit is connected with an input end of the upper computer.

### TECHNICAL FIELD

The present disclosure relates to the field of sensors, and more particularly, to a testing system based on sensitivity of a humidity sensor.

### BACKGROUND

With the improvement of the quality of life, people's demand for environmental humidity control has also been concerned. Humidity measurement and control plays an important role in various fields comprising industry, agriculture, medical treatment, space flight and so on, such as food production and storage, ammunition production and storage, agricultural greenhouse cultivation, humidity measurement and control of medical wards and manned space vehicles, among which a humidity sensor plays an indispensable and important role.

Most of the existing sensor testing systems analyze the sensor performance by measuring a voltage value or a resistance value of a sensitive material affected by a measuring environment, and are aimed at specific functional sensors and specific test environments. For example, “multifunctional gas sensor testing system” with a patent number 201510464290.X and “gas pressure sensor testing method for braking system and testing system thereof” with a patent number 201310658472.1 test the sensor by measuring a change of a resistance value of the sensor. None of the testing systems above is suitable for a capacitive humidity sensor test.

It would therefore be desirable to improve the technology.

### SUMMARY

For solving the technical problems above, the present disclosure is intended to provide a testing system based on sensitivity of a humidity sensor.

The technical solutions adopted in the present disclosure are as follows:

The present disclosure provides a testing system based on sensitivity of a humidity sensor, which comprises a humidity sensor to be tested, a capacitance measuring circuit and an upper computer, wherein an input end of the humidity sensor to be tested is connected with an output end of a gas quality and flow controller, and an input end of the gas quality and flow controller is connected with an output end of the upper computer through a data collection card; an input end of the capacitance measuring circuit is connected with an output end of the humidity sensor to be tested, and an output end of the capacitance measuring circuit is connected with an input end of the upper computer; and the system further comprises a standard humidity sensor, an input end of the standard humidity sensor is connected with an output end of the gas quality and flow controller, and an output end of the standard humidity sensor is connected with the input end of the upper computer.

As an improvement of the technical solution, the capacitance measuring circuit comprises a low-pass filter module, an AD conversion module and a microprocessor, an input end of the low-pass filter module is connected with the output end of the humidity sensor to be measured, and an output end of the low-pass filter module is connected with an input end of the AD conversion module; and an output end of the AD conversion module is connected with an input end of the microprocessor.

As an improvement of the technical solution, the capacitance measuring circuit further comprises a crystal oscillator circuit module, and the crystal oscillator circuit module is connected with the microprocessor.

As an improvement of the technical solution, the capacitance measuring circuit further comprises a serial port transmitting circuit module, an output end of the serial port transmitting circuit module is connected with the input end of the upper computer, and an input end of the serial port transmitting circuit module is connected with an output end of the crystal oscillator circuit module.

Further, two gas quality and flow controllers are provided, which respectively comprise a quality and flow controller for humid nitrogen and a quality and flow controller for dry nitrogen.

Further, the standard humidity sensor is connected with the upper computer through USB.

Further, a model of the data collection card is NI USB6343.

The present disclosure has the beneficial effects that: aiming at the sensor made of highly light-transmitting humidity-sensing functional material film coated on the conducting glass, the testing system of the humidity sensor provided by the present disclosure sets the required humidity environment, and uses the existing sensor to measure and transmit a measurement result to the upper computer; and meanwhile, uses the sensor to be tested for measurement, and acquire a capacitance change, and determines the sensitivity and accuracy of the sensor to be tested by processing and analyzing two paths of data.

According to the solution, a plurality of humidity sensors can be tested, and the test efficiency is improved; a filter capacitor and the denoising processing are used to effectively reduce the influence of parasitic capacitance, and the test is accurate and reliable; and the solution can be applied to other capacitive gas sensitive sensor tests with strong expansibility.

On the other hand, humidity measurement and control and experiment data acquisition in the test process of the solution can be completed by Labview of the upper computer, with friendly human-computer interface, simple operation, unattended operation and intuitive test.

### BRIEF DESCRIPTION OF THE DRAWINGS

The detailed embodiments of the present disclosure are further described below with reference to the drawings.

FIG. 1 is a structure principle diagram of a testing system of a humidity sensor according to a first embodiment of the present disclosure;

FIG. 2 is a diagram of the testing system according to a second embodiment of the present disclosure; and

FIG. 3 is a principle diagram of a weak-capacitance measuring and acquiring circuit according to an embodiment of the present disclosure.

### DETAILED DESCRIPTION

It needs to be noted that in case of no conflict, the embodiments in the present application and the features in the embodiments can be combined with each other.

The present disclosure provides a testing system based on sensitivity of a humidity sensor, which comprises a humidity sensor to be tested, a capacitance measuring circuit and an upper computer, wherein an input end of the humidity sensor to be tested is connected with an output end of a gas quality and flow controller, and an input end of the gas quality and flow controller is connected with an output end of the upper computer through a data acquisition card; an input end of the capacitance measuring circuit is connected with an output end of the humidity sensor to be tested, and an output end of the capacitance measuring circuit is connected with an input end of the upper computer; and the system further comprises a humidity sensor, an input end of the humidity sensor is connected with an output end of the gas quality and flow controller, and an output end of the humidity sensor is connected with the input end of the upper computer.

As an improvement of the technical solution, the capacitance measuring circuit comprises a low-pass filter module, an AD conversion module and a microprocessor, an input end of the low-pass filter module is connected with the output end of the humidity sensor to be tested, and an output end of the low-pass filter module is connected with an input end of the AD conversion module.

The capacitance measuring circuit further comprises a crystal oscillator circuit module, and the crystal oscillator circuit module is connected with the microprocessor.

The capacitance measuring circuit further comprises a serial port transmitting circuit module, an output end of the serial port transmitting circuit module is connected with the input end of the upper computer, and an input end of the serial port transmitting circuit module is connected with an output end of the crystal oscillator circuit module.

Wherein, two gas quality and flow controllers are provided, which respectively comprise a quality and flow controller for humid nitrogen gas flow rate and a quality and flow controller for dry nitrogen gas flow rate.

Further, the humidity sensor is connected with the upper computer through USB.

Further, a model of the data acquisition card is NI USB6343.

According to the solution, the humidity sensor to be tested comprises a transparent substrate, an electrode structure, a transparent insulating layer film located above the electrode, and a humidity sensing material coated above the insulating layer film, the humidity sensing test package acquires a relative humidity value of a test environment, the weak-capacitance measuring circuit acquires a capacitance value of the humidity sensor which changes along with humidity, the data are transmitted to a computer together, and time domain analysis and document storage are performed to a numerical value through Labview software, so as to facilitate subsequent sensor performance analysis.

According to the solution, a weak capacitance outputted by the humidity sensor made of humidity-sensing material film coated on a conducting glass is measured, which can be expanded to other functional sensor tests integrated on the conducting glass, a large amount of manpower is saved, material resources and financial resources, and the test efficiency is improved.

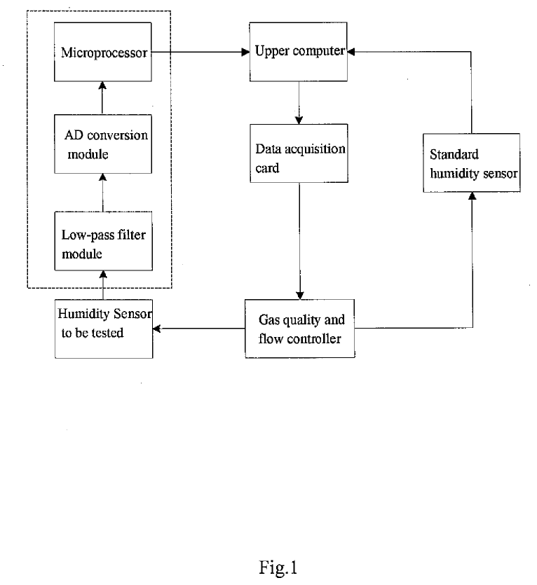

FIG. 1 is a diagram illustrating module connection according to an embodiment of the present disclosure. A testing system of a humidity sensor comprises a computer, a test cavity, a humidity sensor test package, a data acquisition card, a weak-capacitance measuring circuit and a gas quality and flow controller. Wherein, the data acquisition card is connected with two quality and flow controllers and is also connected with the computer; the humidity sensor test package is connected with the computer, wherein the humidity sensor test package comprises a humidity sensor and a data acquisition module, the humidity sensor is connected with the data acquisition module, the data acquisition module is connected with the computer, and humidity measurement data of the humidity sensor are transmitted to the computer; wherein, the humidity sensor is a standard humidity sensor, which is a sensor use in the prior art, such as measurement calibration by the humidity sensor with a model of SHT21 and the like; the weak-capacitance measuring circuit comprises a microcontroller, a low-pass filter circuit, a capacitance digital converting circuit, a serial port transmitting circuit, a crystal oscillator circuit and a connecting port with a sensor to be tested; the low-pass filter circuit is a filter capacitor, and the port is connected with the capacitance digital converting circuit after passing through the filter capacitor, and is finally connected with the microcontroller; the microcontroller is also connected with input ends of the crystal oscillator circuit and the serial port transmitting circuit; and an output end of that serial port transmitting circuit is connected with an input end of the computer, and transmits the humidity measurement data of the sensor to be tested to the computer.

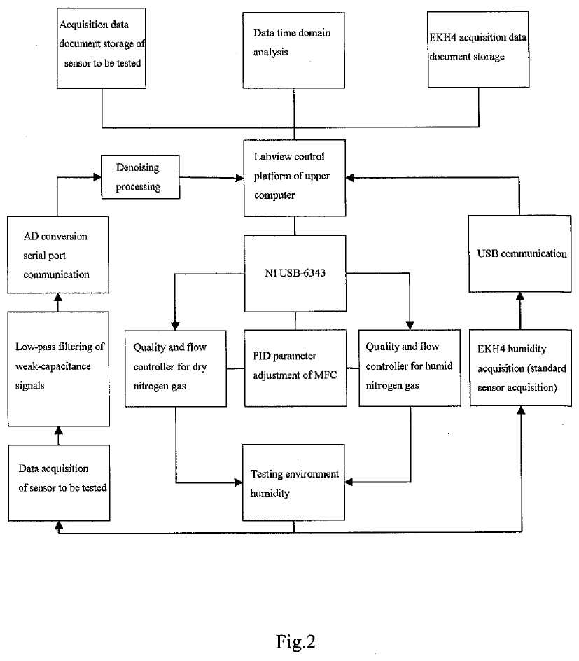

With reference to FIG. 2, the data acquisition card controls the two gas quality and flow controllers by analog signals outputted, so that the two gas quality and flow controllers respectively control flow rates of dry gas and humid gas, coordinately producing the humidity expected for the test environment. The humidity expected for the test is realized by writing data of a control text, and Labview is utilized to transmit a control instruction to the data acquisition card according to the data therein. The control text in the embodiment can utilize Labview programming to increase the humidity of the test environment from 0% to 100% with a gradient of 10%, and then reduce the humidity from 100% to 0%, and the humidity of the environment of each gradient is maintained for 5 minutes. After realizing one gradient humidity, the dry gas needs be introduced for 5 minutes to reduce the humidity of the test environment to 0% before entering the humidity control of the next gradient. In order to check a humidity control accuracy, the humidity of the test environment needs to be calibrated at the same time. In the embodiment, Sensirion EKH4 humidity sensing test package is used, and data of SHT21 humidity sensor are acquired and transmitted to the computer, which are observed and compared with a set value to determine whether the data are within an allowable error range. When the error is within an acceptable range, sensor test data are valid, and then calibration data are compared with the test data to analyze a performance of the sensor to be tested.

A test method for the testing system of the humidity sensor to be tested is to use the data acquisition card to control the two gas quality and flow controllers, so that the two gas quality and flow controllers respectively control the flow rates of the dry gas and the humid gas to be mixed in a certain ratio, thus enabling the test environment to reach the humidity expected for test; and then, the humidity of the test environment is calibrated by the existing humidity sensor to observe whether a preset humidity is reached, when the humidity reaches the acceptable error range, the sensor to be tested is measured and the measurement result is stored, so as to further analyze a performance of the sensor made of highly light-transmitting humidity-sensing functional material film coated on the conducting glass.

The test method of the solution can comprise the following steps.

The existing standard humidity sensor (commercial) and the sensor to be tested are both placed in the test cavity, the sensor to be tested is connected with the weak-capacitance measuring circuit, the data acquisition card is respectively connected with the gas quality and flow controller and the computer provided with Labview software, and the data acquisition module and the weak-capacitance measuring circuit are respectively connected with the computer.

After the connection is completed, the control text instruction in the computer is read through Labview, and the two gas quality and flow controllers respectively controlling the humid nitrogen gas flow rate and the dry nitrogen gas flow rate are controlled, so that the humidity in the test cavity reaches the set value, and then, environment temperature and humidity data acquired by the humidity sensing test package and the capacitance value of a sensitive material to be tested acquired by the weak-capacitance measuring circuit, which changes along with the humidity, are transmitted to the computer for real-time display of a waveform after denoising processing, and the test data are stored in an electronic text format, thus facilitating comparison.

The control text is some numerical values controlling analog quantity outputted by the data acquisition card, which is outputted to the gas quality and flow controller by the analog quantity in a certain ratio to control the humid nitrogen gas flow rate and the dry nitrogen gas flow rate to realize gas matching, so that the humidity of the test cavity is increased from 0% to 100% with a gradient of 10%, and then is decreased from 100% to 0%.

The weak-capacitance measuring circuit is the data acquisition circuit jointly built by the microcontroller, the low-pass filter circuit, the capacitance digital converting circuit, the serial port transmitting circuit, the crystal oscillator circuit and the like, and transmits the capacitance value of the sensor to be tested, which changes along with the humidity, to the computer.

The denoising processing refers to that the capacitance value acquired by the weak-capacitance acquiring circuit is acquired for many times to remove two items with larger errors, and then an average value is obtained.

The test data comprise the environment temperature and humidity data acquired by the humidity sensing test package and the capacitance value of the sensitive material to be tested acquired by the weak-capacitance measuring circuit, which changes along with the humidity.

A curve chart of the humidity changing with time and a curve chart of the capacitance changing with time after denoising are generated according to the test data, and the generated curve charts are used to analyze the performance of the sensor to be tested.

According to the solution, a mature and stable commercial humidity sensor is used as the humidity sensor to test the calibration of environment humidity, and the data are transmitted to the computer by USB communication.

Labview software is used to write a friendly human-computer interaction interface to control two gas quality and flow controllers through analog signals outputted by the data acquisition card NI USB-6343. Wherein, the data acquisition card NI USB-6343 is used to output control signals, which have four analog output channels. The two gas quality and flow controllers respectively control the humid nitrogen gas flow rate and the dry nitrogen gas flow rate to realize gas mixture in ratio to reach the set humidity.

According to the solution, the capacitance value of the highly light-transmitting humidity-sensing functional material film coated on the conducting glass, which changes with the humidity, is measured. A capacitance-to-digital converter AD7746 is used to convert the filtered analog signals into the digital signals, and a Σ-Δ technology is used to realize denoising processing. Level conversion needs to be performed to the data transmitted to the computer by a level conversion chip MAX232, and the data are transmitted to the computer through a RS232 serial port. The time domain analysis and the test data document storage are performed by the computer to the data acquired by each module through Labview software. The system can test a plurality of humidity sensors, and all operations of the system are realized by Labview.

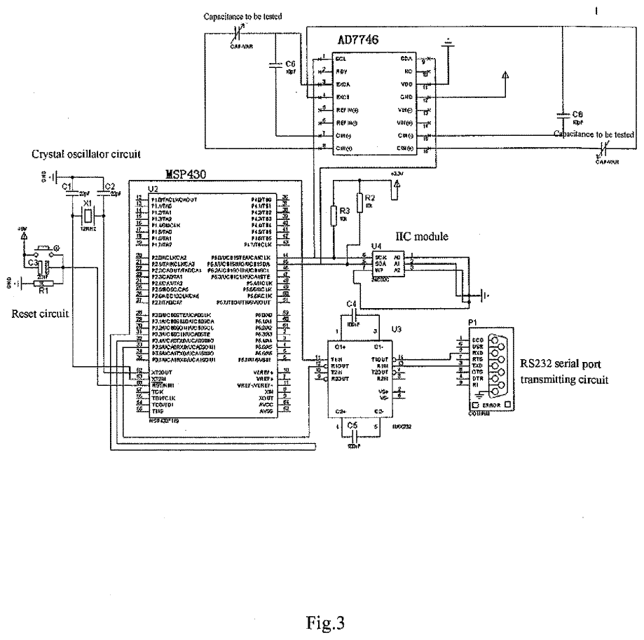

With reference to FIG. 3, the weak-capacitance measuring circuit comprises the capacitance to be tested, the filter circuit, the capacitance-to-digital converter, the crystal oscillator circuit, the microcontroller, the serial port transmitting circuit, etc. Since the measurement signals are fF capacitance signals, and a parasitic capacitance and other electrical noises in the circuit have great influence on capacitance measurement, the filter capacitor needs to be connected to perform low-pass filtering on the capacitance before the signals pass through the capacitance-to-digital converter, then the signals are converted into digital signals through the capacitance-to-digital converter, and the microcontroller MSP430 reads data through an IIC protocol. In order to make the measurement more accurate, the microcontroller takes the average value after removing the two items with larger errors in the signal measurement for many times. Finally, the average value is transmitted to the computer through the serial port transmitting circuit RS232. The crystal oscillator circuit provides an internal clock for program execution of the microcontroller to collect sensor data.

The Labview program of the upper computer can read the control text, control the humidity in the test cavity according to the set program, display the waveform of the sensor data in real time, and store the sensor data for further performance analysis. The program also provides settings for a sampling interval, a humidity maintenance time, and a data document storage path, so that an operator can change parameter setting therein as needed.

According to the testing system of the humidity sensor provided by the present disclosure, and aiming at the sensor made of highly light-transmitting humidity-sensing functional material film coated on the conducting glass, the required humidity environment is set, and the existing sensor is used for measuring and transmitting measurement result to the upper computer; and meanwhile, the sensor to be tested is used for measurement, and a capacitance change is acquired, and the sensitivity and accuracy of the sensor to be tested are determined by processing and analyzing two paths of data.

According to the solution, a plurality of humidity sensors can be tested, and the test efficiency is improved; the filter capacitor and the denoising processing are used to effectively reduce the influence of parasitic capacitance, and the test is accurate and reliable; and the solution can be applied to other capacitive gas sensitive sensor tests with strong expansibility.

On the other hand, humidity measurement and control and experiment data acquisition in the test process of the solution can be completed by Labview of the upper computer, with friendly human-computer interface, simple operation, unattended operation and intuitive test.

The foregoing describes the preferred embodiments of the present disclosure in detail, but the present disclosure is not limited to the embodiments, those skilled in the art can make various equal deformations or replacements without departing from the spirit of the present disclosure, and these equal deformations or replacements shall all fall within the scope limited by the claims of the present disclosure.

1. A testing system based on sensitivity of a humidity sensor, comprising:
a humidity sensor to be tested;
an upper computer;
a capacitance measuring circuit, wherein an input end of the capacitance measuring circuit is connected with an output end of the humidity sensor to be tested, and an output end of the capacitance measuring circuit is connected with an input end of the upper computer;
a gas quality and flow controller, wherein an input end of the humidity sensor to be tested is connected with an output end of the gas quality and flow controller
a data acquisition card, wherein an input end of the gas quality and flow controller is connected with an output end of the upper computer through the data acquisition card; and
a standard humidity sensor, wherein an input end of the standard humidity sensor is connected with an output end of the gas quality and flow controller, and an output end of the standard humidity sensor is connected with the input end of the upper computer.

2. The testing system based on sensitivity of a humidity sensor of claim 1, wherein the capacitance measuring circuit comprises a low-pass filter module, an AD conversion module and a microprocessor, an input end of the low-pass filter module is connected with the output end of the humidity sensor to be tested, and an output end of the low-pass filter module is connected with an input end of the AD conversion module; and an output end of the AD conversion module is connected with an input end of the microprocessor.

3. The testing system based on sensitivity of a humidity sensor of claim 2, wherein the capacitance measuring circuit further comprises a crystal oscillator circuit module, and the crystal oscillator circuit module is connected with the microprocessor.

4. The testing system based on sensitivity of a humidity sensor of claim 3, wherein the capacitance measuring circuit further comprises a serial port transmitting circuit module, an output end of the serial port transmitting circuit module is connected with the input end of the upper computer, and an input end of the serial port transmitting circuit module is connected with an output end of the crystal oscillator circuit module.

5. The testing system based on sensitivity of a humidity sensor of claim 1, wherein two gas quality and flow controllers are provided, which respectively comprise a quality and flow controller for humid nitrogen and a quality and flow controller for dry nitrogen.

6. The testing system based on sensitivity of a humidity sensor of claim 5, wherein the standard humidity sensor is connected with the upper computer through USB.

7. The testing system based on sensitivity of a humidity sensor of claim wherein a model of the data acquisition card is NI USB6343.

8. The testing system based on sensitivity of a humidity sensor of claim 4, wherein two gas quality and flow controllers are provided, which respectively comprise a quality and flow controller for humid nitrogen and a quality and flow controller for dry nitrogen.

9. The testing system based on sensitivity of a humidity sensor of claim 7, wherein a model of the data acquisition card is NI USB6343.
